(19) United States
(12) Patent Application Publication
(10) Pub. No.: US 2021/0129198 A1
(43) Pub. Date: May 6, 2021

(54) Direct drive for rollers, rolls and winches in the steel / non-ferrous industries

(71) Applicant: SMS group GmbH, Düsseldorf (DE)

(72) Inventors: Peter de Kock, Oberhausen (DE); Walter Timmerbeul, Wuppertal (DE); Frank Plate, Düsseldorf (DE)

(73) Assignee: SMS group GmbH, Düsseldorf (DE)

(21) Appl. No.: 16/638,744

(22) PCT Filed: Aug. 15, 2018
(86) PCT No.: PCT/EP2018/072091

§ 371 Date: Feb. 12, 2020

(30) Foreign Application Priority Data
Aug. 18, 2017 (DE) 10 2017 214 412.2

(51) Int. Cl. B21B 35/02; B21B 1/22

(52) U.S. Cl. CPC B21B 35/02; B21B 1/22

(57) ABSTRACT

Device for handling a strip-shaped metal material in metal working, wherein the device comprises: at least one roller element, preferably a roller, a roll or a winch, which is provided for changing the cross-section, for transporting, storing, tension build-up and/or tension release in the strip-shaped metal material, and a drive, which has an electric motor, preferably a torque motor or a synchronous motor, with a stator and a rotor, wherein the device further has a frame, the rotor is connected to the roller element, by which the rotation of the rotor is transmitted to the roller element, and the stator is mounted directly on the frame and/or the rotor is connected directly to the roller element or a shaft of the roller element.

### TECHNICAL FIELD

The disclosure relates to a device for the handling of a metal material in strip form in metal working, wherein the device has a drive and at least one roller element, preferably a roller, roll and/or winch, for changing the cross-section, transporting, storing, building up tension and/or reducing tension of the metal material.

### BACKGROUND

In metal working, a variety of work machines with driven cylindrical or conical rotating rollers, rolls and/or winches are used for material transport, tension build-up and tension release or storage, or for shaping of the material. They are used, for example, in rolling and stamping mills in order to shape steel or non-ferrous metals, and in metal strip processing lines as tension and transport rollers.

Rollers, rolls and winches are driven by a drive train that, in addition to a three-phase motor for generating torque, has other mechanical components for transmitting and changing the torque, such as clutches, gears, brakes, etc. In doing so, there is a technological separation between the machine part to be driven and the electric drive. This separation leads to the fact that the interface between the machine part to be driven and the drive is not optimal.

More precisely, the roller, roll or wind is rotatably connected to a frame via bearings at both ends. The torque is then transmitted from the drive to the roller, roll or winch via one or more clutches, a drive spindle, which can be designed as a cardan shaft, a reduction gear with gear wheels, bearings, braking means and other moving mechanical parts. When controlling such a machine, the problem arises that both the coupling and the transition from the gearbox to the coupling and from the coupling to the rotor of the drive against torsional loads are not torsionally stiff to the required extent. Due to torsional resilience, the speed and the angle of rotation of the roller, roll or winch can oscillate against the drive, which can lead to problems with control accuracy. This problem, that is, the precise and reliable transmission of the torque of a speed-controlled or position-controlled electric motor to the machine part to be driven, occurs particularly when driving rollers with a large moment of inertia, such as support rollers in a rolling mill.

The drive design disclosed above also takes up a lot of space and must be mounted underneath the roller, roll or winch in the foundation, in order to allow the maintenance and replacement of the roller, roll or winch in a practical manner. This leads to high costs and power losses in the drive train. Many moving parts have to be protected by protection devices; they also lead to high maintenance requirements and reduce reliability. It is also difficult and expensive to design a conventional drive train for a high overload.

### SUMMARY

One task of the disclosure is to specify a device for changing the cross-section, transporting, storing, building up tension build and/or releasing tension of a strip-shaped metal material, which overcomes at least one of the aforementioned technical disadvantages. In particular, the device should have a high degree of reliability and control accuracy with a compact design and low costs.

The task is solved with a device as claimed.

The device is used for the handling of a strip-shaped metal material in metal working, in particular for changing the cross-section, transporting, storing or buffering, building up tension and/or releasing tension of metal strips made of steel or non-ferrous metals, the so-called “NF metals.”

The device has at least one roller element. The term “roller element” includes any cylindrical—not only circular-cylindrical—rotatably mounted body, which is designed for changing the cross-section, transporting, accelerating, building up tension and/or releasing tension of metal strips. The device also has a frame. The frame may be open or closed; in particular, housings, base frames and the like fall under the designation of “frame.” In accordance with a preferred embodiment, the frame has one or more bearings for the rotatable mounting of the roller element or a shaft connected to the roller element. The roller element is preferably a roller, roll or winch. In the case of a winch, the roller element thus does not come into direct contact with the strip material, but serves as a cable winch, preferably for a horizontal or vertical strip accumulator. Such a strip accumulator is used in strip processing lines, in particular rolling mills, to continuously supply the processing machines with strip material. System areas with different processing speeds or a discontinuous system area and a stable strip run can be connected to each other by means of the strip accumulator, in that the strip material is stored or buffered by the strip accumulator.

Furthermore, the device has at least one drive, which has an electric motor with a stator and a rotor. The electric motor can be designed as a compact motor with its own bearings or without bearings. The electric motor can be a permanently excited three-phase motor; it preferably has a motor housing or motor frame in which the rotor is mounted, which is, for example, set in rotation in the conventional manner by the force exerted by a magnetic field on current-carrying conductors of a coil. Alternatively, the frame of the device or a part of it can be used as the motor housing. The electric motor is preferably a torque motor or synchronous motor. Such motors can generate very high torques at relatively low speeds, making them particularly suitable as motors for direct drives. For example, when using a torque motor, a reduction gear can be omitted in many cases. The rotor is connected to the roller element, by which the rotation of the rotor is transmitted to the roller element. The stator is mounted directly on the frame of the device and/or the rotor is connected directly to the roller element or the aforementioned shaft of the roller element. If the stator of the drive is directly connected to the frame, the frame of the machine and the drive are “interlocked” together in this manner. Any drive housing or motor housing, drive frame or motor frame is thereby considered part of the stator. In the case of a “direct connection,” “direct attachment” or “direct mounting” within the meaning of the present application, the mechanical components concerned are in direct contact with each other, preferably in a rigid manner. This may be achieved, for example, by screwing, riveting or welding, but a one-piece design is also included.

In accordance with the above structure, the drive acts as a direct drive for the rotary operation of the roller element. On the one hand, the special integration achieves an extremely high torsional stiffness between the electric motor and the roller element, and on the other hand, costly mechanical components such as gears, clutches, cardan shafts, etc. can be omitted in the drive train. This simplifies the drive train, making it compact, low-maintenance, light and reliable. The device achieves, at low cost, an improvement of the control characteristics of the roller element, due to the high torsional stiffness. In addition to weight reduction, this also leads to an improvement in energy efficiency. The foundations and halls for accommodating the machine can be reduced in size. Furthermore, the drive system shown here allows a simple increase in drive power, for example when the system is being rebuilt or modernized, for example if new materials are to be processed, without having to replace the existing drive. By reducing the number of components, the maintenance work on the device is reduced, which can extend the production time of the system. Furthermore, this is accompanied by a reduction of safety-technology related expenses. As a whole, the degrees of freedom of the machine are increased in terms of function and design. The reduction in the drive train is favorable with regard to the possible standardization or normalization of such drive systems. Due to the particular proximity of the drive to the roller element, the frame can also be used as a cooling element or cooling surface for the electric motor. A possible feed-through for media such as hydraulic oil and/or cooling water is also possible from the drive side of the roller element. With conventional strip or roll systems, so-called “chatter marks” or shades can occur on the processing material due to the “rotationally soft” drive. These are generated by drive vibrations in the traditional, complex drive train. The problem can be reduced or solved by the direct drive in accordance with the disclosure.

The electric motor is preferably formed as an inrunner, wherein the rotor is connected directly to the roller element or directly to a shaft of the roller element. In accordance with a particularly preferred embodiment, this includes a one-piece design of the rotor and the shaft or the rotor and the roller element. This further improves the torsional stiffness between the drive and the roller element.

Alternatively, the electric motor of the drive can be designed as an outrunner, wherein, thereby, a shell section of the roller element is connected to the rotor. A “shell section” is not only the outermost circumference of the cylindrical roller element, but also includes sections further inside, to the extent that they allow a connection with the outer running rotor. The shaft, if the roller element has one, can be mounted in the frame or in the drive on the drive side in accordance with this embodiment. However, embodiments, in which a shaft can be omitted due to the close connection of the shell section with the rotor, are also possible. The shell section of the roller element and the rotor are preferably connected directly to each other to further improve the torsional stiffness, whereby a one-piece or partially one-piece design is included in accordance with a particularly preferred embodiment.

To further reduce mechanical components, the frame preferably supports the roller element on one side only, while on the opposite side, i.e. the drive side, the roller element is supported in the drive via the shaft or the rotor. In this manner, the roller element and the rotor can share one bearing. Alternatively, the shaft can be supported by two bearings on the frame, by which a bearing for the rotor in the drive unit may not be necessary.

Preferably, two drives on opposite sides of the housing are connected to the roller element, in order to distribute the force and weight evenly and/or to increase the drive power while maintaining a compact installation space.

The rotor of the drive is preferably connected to the roller element without the interposition of a torque gear, in particular without the interposition of a reduction gear. By omitting a torque gear, a direct and immediate torque transfer from the drive to the roller element takes place. The term “torque gear” covers all those forms of a transmission that convert an input torque or input speed into an output torque or output speed of a different magnitude, which thus perform a torque conversion or speed conversion.

In certain design variants, the drive can be connected to the shaft via a spindle and/or a cardan shaft. This is especially important for drives with high power or in adverse environmental conditions, such as in hot rolling mills.

Preferably, the drive has at least one catching magnet, which can be arranged in a ring around a rotor extension, for example. The catching magnet is configured to catch magnetic particles and keep them away from the electric motor. This prevents magnetic particles from getting into the electric motor despite the integral structure of the drive, by which the reliability of the drive is improved.

In accordance with a preferred embodiment, the drive has a brake and/or holding device in addition to the electric motor, for rapid braking and, if necessary, the locking of the roller element.

The drive disclosed above can be structured in a modular manner. If required, the drive can be expanded by additional modules, which are preferably cylindrical or disk-shaped. Possible expansion modules include, for example, a braking module, a holding module, a power increase module with drive means (such as rotor and stator) to increase the power of the base module, a gear module and/or a cooling module. In order to allow the modules to be combined with each other, they have technically compatible components, in particular housings or frames that can be connected or flanged to each other. Such a modular design can increase the repeatability of identical parts (motor disks, stator disks, stator laminations, stator coils, brake disks, brake pads, etc.), thus reducing costs and increasing the reliability of the device.

The drive preferably has a rotary encoder or a speed sensor for measuring the angle of rotation and/or the rotational speed. The rotary encoder can be provided as a separate module or as a component of a module. Alternatively, a driving mode without an encoder is possible.

The drive can also be equipped with a cooling device. This can, for example, be arranged as a separate module between the brake and the electric motor and/or as a cooling shell in or on the motor housing of the drive. The cooling can be provided, for example, by means of a blower and/or as a water or fluid cooling device.

A possible feed-through for media, such as hydraulic oil and/or cooling water, is possible through the rotor of the drive. Furthermore, the drive can have one or more integrated converters.

The direct drive shown is used particularly preferably: in a rolling mill, wherein the roller element is a support roll or a work roll, a metal strip processing line, wherein the roller element is a transport roller, a tension roller, an acceleration roller or a roller for the tension build-up or the tension release of the metal strip, or a strip accumulator with a winch assembly, wherein the roller element is a cable winch.

Preferably, the drive has a coupling for the rotor, in particular preferably a curved-tooth coupling. In the integrated design, this allows compensation for small misalignments between the drive and the roller element, if necessary. It may also be useful to be able to release the roller element quickly by means of a coupling, in order to disconnect the roller element from the drive in an emergency or under certain operating conditions.

The drive preferably has: an electric braking device, which is configured to brake the device, i.e. to brake the drive and/or the roller element, from a operating state without friction into a holding state, in which the roller element is essentially stationary; a mechanical holding device, which is configured to mechanically lock the device in the holding state upon the actuation of the mechanical holding device; and a control device, which is configured to control the electrical braking device and the mechanical holding device, such that essentially all the kinetic energy is converted by the electrical braking device, while the mechanical holding device is actuated only in the holding state of the device.

In this preferred embodiment, braking is frictionless by means of an electrical braking device. In this context, “frictionless” means the absence of mechanical friction; braking in this sense is contact-free. Internal material processes that can occur during electrical braking, such as counter or eddy currents, are therefore not covered by the terms “friction,” “frictionless” and the like. Preferably, the electric motor is braked in a normal operating state on the controlled ramp of a supplying converter, which supplies the electric motor with power, for example by adjusting the frequency and voltage. The electrical braking device, which can be designed as a counter-current brake or eddy-current brake, for example, works frictionless and is therefore essentially wear-free. After the device has reached the holding state by braking by means of the electrical braking device, in accordance with this preferred embodiment, the device is mechanically locked by actuating a mechanical holding device. The locking preferably takes place in a force-fitting or positive-locking manner. The mechanical holding device can, for example, act on a retaining disk via retaining jaws; it can be provided on the roller element or on the shaft of the roller element or even on the rotor of the electric motor. The electrical braking device and the mechanical holding device are now controlled by the control device in such a manner that essentially all the kinetic energy is dissipated or converted by the electrical braking device, while the mechanical holding device is only actuated when the device is in the holding state. Thus, the mechanical holding device has the technical function of fixing or locking the device in the holding state, i.e. in the stationary position, without dissipating kinetic energy through friction.

As a result, the mechanical holding device can be made particularly compact, as it essentially does not have to convert kinetic energy. It has no wearing parts; at least, wear takes place only to a small extent. Furthermore, abrasion particles from the mechanical holding device being able to penetrate into the drive is prevented. Thus, if, in this connection, it is said that the device, roller element or shaft is “essentially” stationary in the holding state or “essentially” all the kinetic energy is converted by the electrical braking device, it is meant that the electrical braking device is designed to dissipate all the kinetic energy from the operating state, whereas the mechanical holding device does not make a contribution in this respect. Small energies arising from a creep movement, for example, arising from vibrations and the like, can be absorbed and converted by the mechanical holding device.

Preferably, a supplying converter is provided; this supplies power to the electric motor of the drive in the operating state and has the above-mentioned function of braking the device in a normal operating state. In an extraordinary operating state, the supplying converter is preferably galvanically isolated from the electric motor for braking and the device is brought into the holding state by short-circuiting the windings of the electric motor via a braking resistor and/or a resistor/capacitor circuit and/or directly, and/or by connecting an external DC voltage source. Thus, the mechanical holding device does not have to convert any kinetic energy from the operating state to the holding state, even in an extraordinary operating state, for example in the event of a fault in the supplying converter. The entire kinetic energy of the roller element and the drive is preferably converted by the electrical braking device in all operating states—for example, stop, quick stop, emergency stop, emergency shut-off. Therefore, preferably in any case—even in an emergency—the mechanical holding device only takes over the technical function of fixing or locking the device in the standstill position.

Preferably, the mechanical holding device is actuated electrically, mechanically, hydraulically or pneumatically. Retaining jaws, retaining disk, piston, hydraulic or pneumatic cylinders and lines, retaining clamps, retaining pin—all such components suitable for the construction of the mechanical holding device can be designed for low forces and can therefore be implemented compactly, easily and cost-effectively.

The supplying converter may include other motor control functions, preferably a speed measurement and/or a method for adjusting the rotating field depending on the current state of the machine.

The drive with electrical braking device and mechanical holding device, presented in accordance with a preferred embodiment, is particularly well-suited as a direct drive. This is because, with a direct drive for rollers and winch rollers, it must be possible, as explained above, to hold very high torques by a brake. While conventional brake calipers require a large installation space for this purpose, the combination of the electrical braking device and the mechanical holding device described is optimally suitable for use with a direct drive.

The disclosed direct drive is particularly suitable for rollers, rolls and winches in rolling mills and plants for processing metal strips and sheets. In particular, it includes work, support and stamping rolls in a rolling mill, tension rollers, transport rollers, rollers for tension build-up or tension release, acceleration rollers, coating rollers and cable winches. However, the invention may also be applied in other fields, to the extent that it concerns the handling of strip-shaped metal materials, in particular steel and non-ferrous metals.

Further advantages and features of the present invention can be seen from the following description of preferred exemplary embodiments. The features described there may be implemented on their own or in combination with one or more of the features set out above, provided that the features are not contradictory. Thereby, the following description of preferred exemplary embodiments is given with reference to the accompanying drawings.

### BRIEF DESCRIPTION OF THE DRAWINGS

FIG. 1 schematically shows the structure of a machine that has a direct drive with an electric motor, a work machine to be driven by the direct drive and a device for braking the machine.

FIGS. 2a and 2b schematically show devices with a roller/roll and a direct drive as an inrunner.

FIG. 3 schematically shows a device with a roller/roll and a direct drive as an outrunner.

FIG. 4 schematically shows a device with a roller/roll and a direct drive with a supported rotor.

FIG. 5 schematically shows a device with a roller/roll and a direct drive with an unsupported rotor and a cooling shell.

FIG. 6 schematically shows a device with a roller/roll and a direct drive with an unsupported rotor and a cooling module.

FIG. 7 schematically shows a device with a roller/roll and a direct drive as a variant with a replaceable roller body and an axial cooling device.

FIG. 8 schematically shows a winch assembly with cable winches and associated direct drives, wherein the direct drives are designed as inrunners.

FIG. 9 schematically shows a winch assembly with cable winches and associated direct drives, wherein the direct drives are designed as outrunners.

FIG. 10 schematically shows a cable winch and a direct drive connected to it, wherein the direct drive is designed as an inrunner.

FIG. 11 schematically shows a cable winch with direct drives mounted on both sides, wherein the direct drives are designed as inrunners.

FIG. 12 schematically shows a cable winch and an associated direct drive, wherein the direct drive is designed as an outrunner.

FIG. 13 schematically shows a cable winch with direct drives mounted on both sides, wherein the direct drives are designed as outrunners.

### DETAILED DESCRIPTION

In the following, preferred exemplary embodiments are described on the basis of the figures. Therein, identical, similar or similarly acting elements are provided with identical reference signs, and a repeated description of such elements is sometimes omitted in order to avoid redundancies.

Before exemplary embodiments of devices with a direct-driven roller, roll or winch are presented, an exemplary drive suitable for direct drive is to initially be described, as it is equipped with a holding device that, by a combination of an electrical braking device and a mechanical holding device, is capable of reliably braking high torques despite its compact design.

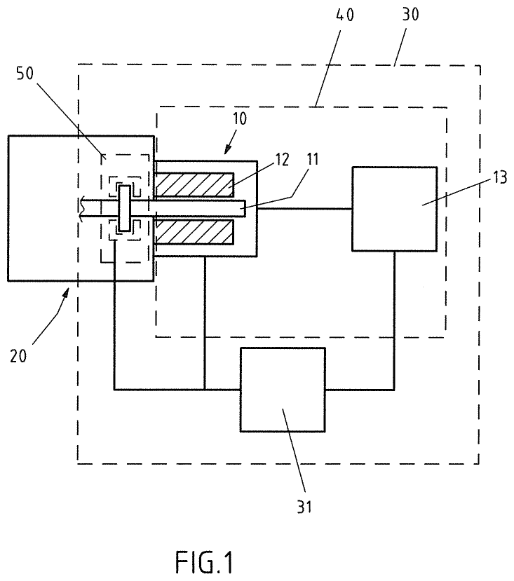

FIG. 1 schematically shows the structure of a machine that has a drive 10 with an electric motor, a work machine 20 to be driven by the drive 10, which has a roller element, such as a roller, roll or winch, and a holding device 30 for braking the machine. The holding device 30 has an electrical braking device 40 and a mechanical holding device 50.

The work machine 20 to be driven by the drive 10 can be designed in many different manners, for example as one or more work and/or support rolls in a rolling mill, tension roll or transport roll, as a coiler, coating machine, flying shear, winch in a vertical or horizontal accumulator, etc.

The electric motor, preferably a synchronous motor or torque motor, of the drive 10 has a rotor 11 and a stator 12, which is preferably attached directly to a frame or housing of the work machine 20. The rotor 11 is connected to a shaft of the work machine 20, by which the rotation of rotor 11 is transmitted to the shaft and thus to moving parts of the work machine 20. In the case of a “direct” fixing or connection, or, synonymously, an “integral” fixing or connection within the meaning of the present application, the mechanical components concerned are in direct contact with each other. This may be achieved, for example, by screwing, riveting or welding, but a one-piece design is also included. The work machine 20 and the drive 10 are “interlocked” in this manner. On the one hand, the special integration achieves an extremely high torsional stiffness between the drive 10 and the shaft of the work machine 20.

The close integral connection between the drive 10 and the work machine 20 allows for a system construction that saves installation space. This is accompanied by simplifications in system construction, for example by saving on foundations, better accessibility to the system, a reduction in spare parts, a reduction in maintenance work, a downsizing of the hall. The motors are not endangered, or are less endangered, by bundles or other falling parts. A major advantage of the drive concept presented here becomes clear in the thermal design of the motors. Due to the intimate connection of the drive 10 to the work machine 20, the mass and surface of the mechanical device can be used for heat dissipation. Thus, the power of the electric motor can be increased without any structural measures. The power loss of the drive train is considerably reduced. In many cases, forced ventilation or water cooling can be omitted. The drive 10 can be designed as an inrunner or outrunner. The integral concept also offers improvements in terms of safety, since rotating external drive components such as cardan shafts, clutches, brake disks, etc. can be omitted. Components such as bearings, shafts, clutches, motor stands, gear stands, etc. are no longer required. A reduction in the number of moving parts also results in higher control accuracy, which in turn has a positive effect on the quality of the products to be manufactured.

The holding device 30 has a control device 31 that controls the electrical braking device 40, the mechanical holding device 50 and, if necessary, functions of the drive 10 and/or its supplying converter 13. In the following, control functions of the control unit 31 are described for various operating states, in particular the normal operating state and an extraordinary operating state:

For braking or stopping the work machine 20, the holding device 30 is provided; this has the electrical braking device 40 and the mechanical holding device 50. Thereby, the control via the control device 31 takes place in such a manner that the electrical braking device 40 takes over the braking of the work machine 20 in a frictionless manner until it comes to a standstill or almost to a standstill, while the mechanical holding device 50 locks or holds the work machine 20 after reaching the standstill position. This can be achieved by a positive-locking or force-fitting connection, for example by means of a brake disk running on the rotor 11 or the shaft of the work machine 20, which is pressed against the brake pads on both sides. The control can take place electrically, mechanically, hydraulically or pneumatically. A slight deceleration from an almost stationary state of the work machine 20 to an absolute standstill can be taken over by the mechanical holding device 50, as described above.

In the normal operating state, the drive 10 is braked on the controlled ramp (frequency, voltage) of a supplying converter 13. This supplying converter 13, which supplies the motor of the drive 10 with power, is an electronic device and can be part of the drive 10, part of the work machine 20 or an independent component. The electric motor of the drive 10 can be designed as a three-phase motor. In addition to the power supply, the converter 13 can include additional functions for motor control, such as speed measurement and/or procedures for adjusting the rotating field depending on the current state of the machine. In particular, the converter 13 includes a function for braking the work machine by adjusting the frequency and voltage until the work machine 20 comes to a standstill or almost to a standstill.

In the event of a fault of the converter 13, the braking of the drive 10 or work machine 20 is not possible in this manner. The electrical braking device 40 is configured in such a manner that, in this case, the converter 13 is galvanically isolated from the motor of the drive 10, while at the same time the motor windings are short-circuited via a braking resistor, a resistor/capacitor circuit or directly, or an external DC voltage source is connected. This ensures that the work machine 20 can be braked quickly in an emergency.

In particular, the structure of the electrical braking device 40 described above permits frictionless (that is, non-mechanical) braking of the work machine 20 not only in normal operation, but also in the event of a fault in the supplying converter 13. The entire kinetic energy of the work machine 20 and the drive 10 is dissipated or converted by the electrical braking device 40 in all operating states—for example, stop, quick stop, emergency stop, emergency shut-off. Now, in any case (even in an emergency), the mechanical holding device 50 only assumes the task of fixing the work machine 20 in the standstill position. By braking the work machine 20 in all operating states solely on the basis of the electrical braking device 40, the energy is not converted into heat by the mechanical holding device 50. No energy is converted into friction, and this applies not only to normal operation, but also in particular in the event of a fault in the supplying converter 13. The mechanical holding device 50 can therefore be designed to be particularly compact, as it does not need to convert kinetic energy even in an emergency. In addition, the mechanical holding device 50 does not have any wearing parts; at least, wear takes place only to a small extent. This also prevents abrasion elements from the mechanical holding device 50 from penetrating into the drive 10. Preferably, the mechanical holding device 50 is integrated in the housing of the drive 10 or directly flanged to it. The mechanical holding device 50 and the electrical braking device 40 can be parts or modules of a modular motor system for the drive 10.

The drive 10 described above functions as a direct drive, which means that the complexity of conventional drive trains (consisting, for example, of an electric motor, a motor coupling including a brake, a reduction gear and a machine coupling) can be significantly reduced. The drive 10, in particular the stator 12 of the drive 10, is preferably located directly on or in the work machine 20.

The drive 10 shown here can be structured in a modular manner. The electric motor as a base module is extended in this sense by the mechanical holding device 50 and the electrical braking device 40 as modules. The drive 10 can be extended by additional modules if required. Possible extension modules include, for example, a power increase module with drive means (rotor and stator) to increase the power of the base module and/or a cooling module that cools the drive and, if necessary, parts of the work machine by means of a blower or fluid cooling. In order to allow the modules to be combined with each other, they have technically compatible components, in particular housings that can be connected or flanged to each other. Such a modular design can increase the repeatability of identical parts (motor disks, stator disks, stator laminations, stator coils, etc.), thus reducing costs and increasing the reliability of the device.

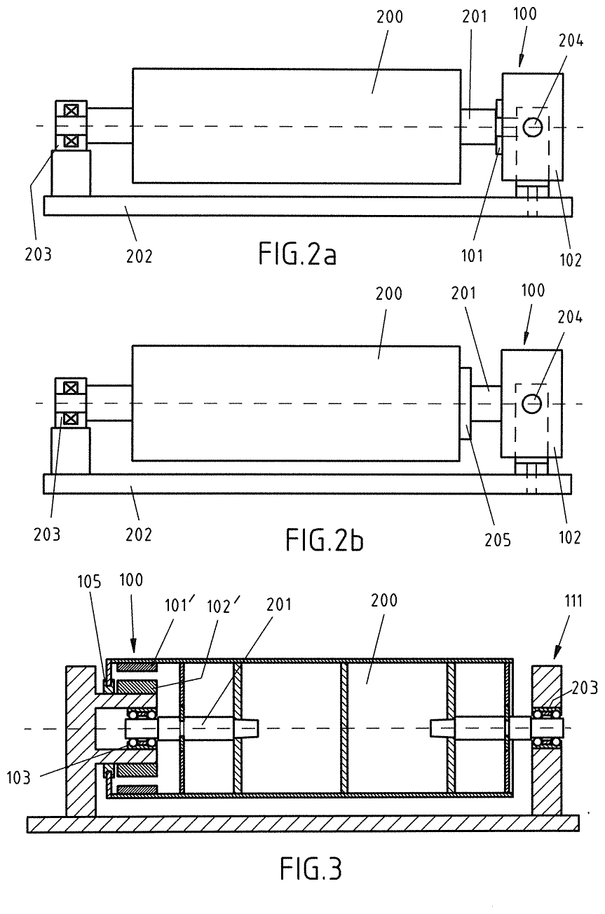

FIGS. 2a and 2b schematically show devices with a drive 100 designed as an inrunner, which may be, for example, the drive 10 shown above, and a roller or roll (also referred to as “roller/roll”) 200 directly driven by the drive 100. The roller/roll 200 can be, for example, a tension roller or a work or support roll in a rolling mill. The roller/roll 200 can also be designed as a coater or coating roller, with which a layer, such as a layer of paint, varnish, stain, etc., can be applied to the material to be processed.

To connect the roller/roll 200 to the drive 100, FIG. 2a shows a variant with which the roller/roll 200 has a shaft 201, also known as a shaft journal, which in turn is directly connected to the rotor or armature 101 of the drive 100; for example, it is clamped in it. In this manner, the roller/roll 200 is directly or integrally connected to the rotor 101 of the drive 100. The rotor 101 and the shaft 201 are formed in one piece in accordance with a particularly preferred design variant.

In the systematics of FIGS. 2a to 13, the drive is designated with the reference sign 100, instead of the reference sign 10 of FIG. 1, to make it clear that the drive shown in FIG. 1 is an exemplary, albeit preferred drive. This distinction applies analogously to the components of the drive provided with reference signs, such as the rotor 11 in FIG. 1 and the rotor 101 in FIG. 2a and other exemplary embodiments.

The reference sign 202 designates the frame or stand of roller/roll 200, which has a bearing 203 for rotatably supporting the roller/roll 200 on one side. Due to the direct connection to the drive 100, a bearing on the drive side for the roller/roll 200 can be omitted if necessary, as shown in FIG. 2a. Instead, the housing 102 or the stator of the drive 100 is connected to the frame 202 via a cardanic suspension 204.

Thus, the device has a drive 100 for the rotary operation of the roller/roll 200, wherein, on the one hand, a high torsional stiffness between the drive 100 and the roller/roll 200 is ensured, and, on the other hand, one or more conventional components in the drive train, such as gears, couplings, cardan shafts, etc., can be omitted.

The exemplary embodiment in FIG. 2b shows a device similar to that in FIG. 2a, wherein the connection between the drive 100 and the roller/roll 200 is made by means of a flange 205. In this example, it is also clearly visible that a bearing on the motor side of the roller/roll 200 is omitted or taken over by the drive 100. The suspension 204 and the frame 202 are also used to support the end on the drive side of the roller/roll 200.

FIG. 3 schematically shows a device with a roller/roll 200 and a direct drive 100, the structure of which differs from the variants in FIGS. 2a and 2b essentially in that the drive 100 is designed as an outrunner. For this purpose, the stationary parts of the electric motor (that is, the stator 102′) are located inside the drive 100, while the rotor 101′ rotates around the stator 102′ on the outside. In such a case, the rotor 101′ can pass directly into the roller/roll 200, can be formed in one piece with it or can be rigidly connected to the roller/roll 200. For this purpose, the shell section of the roller/roll 200 is in contact with the rotor 101′. In this context, the “shell section” does not only include the outermost circumference of the cylindrical roller/roll 200, but also includes sections that lie radially outside the shaft 201 of the roller/roll 200, provided that they allow the roller/roll 200 to be connected to the outer rotor 101′. The shaft or shaft journal 201 is rotatably mounted in a bearing 103 integrated in the drive 100, which bearing is mounted in a bearing housing. In certain exemplary embodiments, with an external bearing of the rotor 101′ or the roller/roll 200, a shaft journal 201 and its bearing 103 may be omitted if required.

Moreover, in the example in FIG. 3, the stator 102′ is rigidly connected mechanically to the frame 202. In the illustration of FIG. 2, a brake 105 integrated in drive 100 is shown; this can be designed as a high-performance brake that can be actuated by compressed air, for example. The integrated brake 105 can also correspond to the mechanical holding device 50 from the version shown in FIG. 1, wherein the braking and holding of the device takes place in the combined electrical and mechanical manner described in this respect. It is also possible to use the embodiment of in FIG. 1 for the previous and following examples, without this being explicitly stated in each case. Furthermore, the device of the present exemplary embodiment in FIG. 3 is equipped with an encoder system 111 which, as a rotary encoder or a speed sensor, measures the angle and/or speed of rotation of the roller/roll 200.

Thus, the device in FIG. 3 has a drive 100 for the rotary operation of the roller/roll 200, wherein, on the one hand, a high torsional stiffness between the drive 100 and the roller/roll 200 is ensured, and, on the other hand, one or more conventional components in the drive train, such as gears, couplings, cardan shafts, etc., can be omitted.

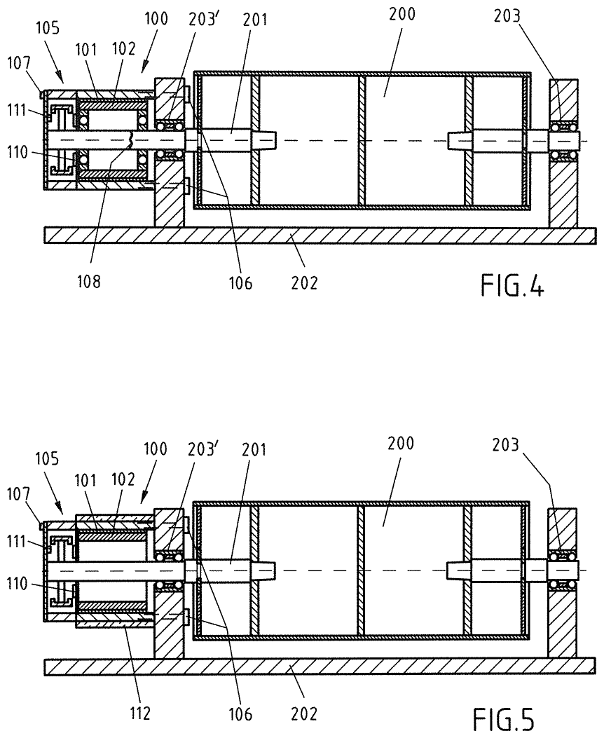

FIG. 4 schematically shows a device with a roller/roll 200 and a direct drive 100 as an inrunner, with a rotor 101 supported by bearings 109. With this exemplary embodiment, the roller/roller 200 is supported on both sides of the stand 202 by means of bearings 203 and 203′. Due to the close integration, the second bearing 203′ can also be regarded as a component of the drive 100. The roller/roll 200 is directly connected to the drive 100 via the shaft journal 201. The stator 102 is directly bolted to the stand 202 via a bolting 106, which provides a torsionally stiff power transmission from the drive 100 to the roller/roll 200. The drive 100 also has a brake module 105, which is actuated, for example opened, via a pneumatic connection 107. The brake module 105 has a brake disk and brake shoes, which are shown in the figure without reference signs. For technical details of an exemplary high-performance brake, please refer once again to FIG. 1 and its description. In the exemplary embodiment in FIG. 4, the drive 100 also has a flexible coupling 108 with bearings 109, which allows the rotor 101 to be quickly separated from the shaft journal 201 of the roller/roll 200. To compensate for smaller misalignments between the roller/roll 200 and the drive 100, a curved-tooth coupling (not shown) can be provided in the shaft journal 201. Catching magnets 110 are used to keep magnetic particles, which can be generated by the operation of brake 105, away from the drive components. The drive 100 is also equipped with an encoder system 111, which measures the angle of rotation and/or the speed of rotation of the roller/roll 200 as a rotary encoder or speed sensor.

The embodiment of FIG. 5 differs from that of FIG. 4 in that the rotor 101 is unsupported at the drive side. Due to the integral or one-piece design of the rotor 101 and the shaft 201, the bearings 203′ and 203 of the roller/roll 200 are also used by the drive 100. In addition, the drive 100 of FIG. 5 has a cooling shell 112. The cooling shell 112 is part of a cooling device, with which the drive 100 can be optionally equipped. The cooling shell 112 may be provided in the housing of the drive 100 or, as shown in FIG. 5, directly on the stator 102, which, as a generic term in the present application, comprises the housing of the drive 100.

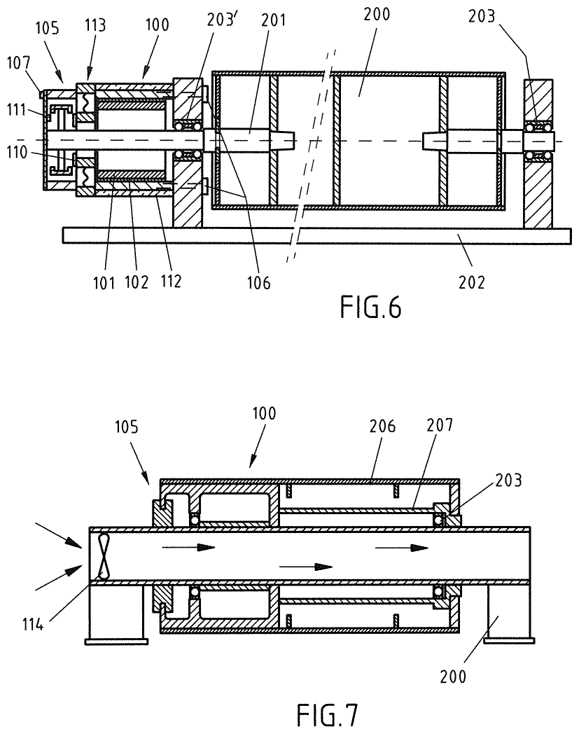

An alternative form of cooling is realized by means of a cooling module 113 in accordance with the embodiment in FIG. 6, which is arranged as a separate cylindrical module between the high-performance brake 105 and the electric motor of the drive 100. The cooling can be provided by a blower and/or as a water or fluid cooling device. FIG. 6 shows how the base module of the drive 100 can be expanded by two additional modules—the cooling module 113 and the high-performance brake 105.

FIG. 7 schematically shows a device with a roller/roll 200 and a direct drive 100 as a variant with a replaceable roller body 206. The roller body 206 is seated on a roller base frame 207. In the present exemplary embodiment, the cylindrical shell of the roller body protrudes beyond the drive 100, such that it is at least partially accommodated in the roller/roll 200 and integrated in this manner. Where required, for example for maintaining the machine or changing the diameter or other properties of the roller/roll 200, the roller body 206 can be easily dismantled and, if necessary, replaced by interacting in a modular fashion with the roller base 207 and the drive 100. FIG. 7 also shows another cooling variant, which is realized here as axial cooling device 114. A pipe runs along the center axis of the overall cylindrical construction consisting of the drive 100 and the roller/roll 200, through which a cooling fluid flows to cool the drive 100 and the roller/roll 200 from the inside.

FIGS. 2a to 7 related to exemplary embodiments for rollers/rolls, for example support rollers or rolls in a rolling mill, transport or acceleration rollers. In the following, exemplary embodiments are described that relate to the direct drive of cable winches used in horizontal or vertical strip accumulators.

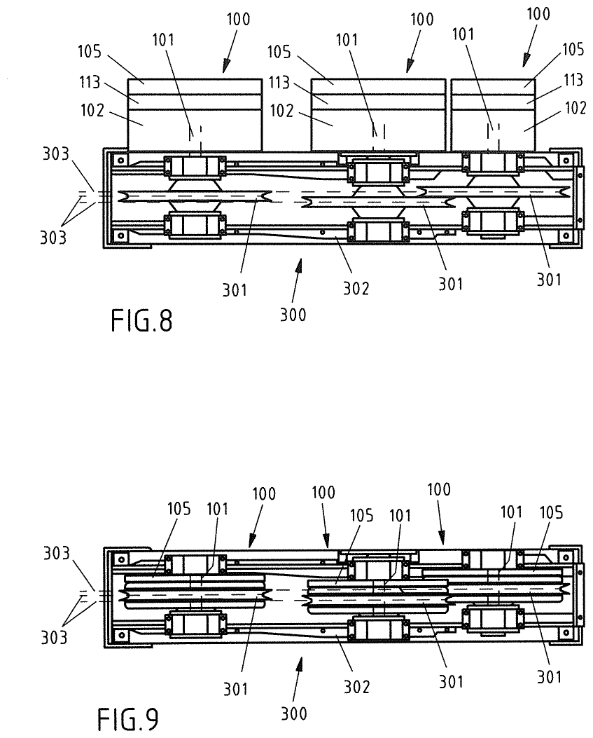

In strip processing lines, in particular rolling mills, strip accumulators are used to continuously supply the processing machines with strip material. For this purpose, strip accumulators separate, for example, a discontinuous system area (inlet, outlet, SPM, etc.) from the stable strip run (furnace, zinc pot, coater, etc.). The strip is thereby held in a strip loop of variable size by one or more deflection rollers. Winch assemblies such as those shown in FIGS. 8 and 9 can be used to adjust the strip loop.

The winch assembly 300 in FIG. 8 has several (in this example, three) winches 301, which are rotatably mounted in a winch frame 302 and act as cable winches for a horizontal accumulator. In this example, each winch 301 is rotatably driven by one drive 100, which are designed as direct drives, as a so-called “mine drive.” A cable that is wound up and unwound by means of the winch assembly 300 is designated with reference sign 303. In the present exemplary embodiment of FIG. 8, the direct drives 100 are designed as inrunners, wherein each direct drive 100 is of modular design, consists of an electric motor with a stator 102 and a rotor 101, a brake module 105 and a fan module 113 arranged between the brake module 105 and the electric motor. In the present exemplary embodiment, the stator 102 is directly and mechanically rigidly attached to winch frame 302. To provide very high torques, a reduction gear can be integrated in the direct drive 100, but in accordance with a preferred embodiment, such a reduction gear is not required.

The exemplary embodiment of FIG. 9 differs from that of FIG. 8 in that FIG. 9 shows a variant of the winch assembly 300 with which the direct drives 100 are designed as outrunners. The direct drives 100 each have an outer rotor 101, which is directly and mechanically rigidly connected to the associated winch 301, in order to set it in rotation, an inner stator (not shown) and a brake module 105. In this manner, the drive 100 is installed directly in the winch frame 302, wherein the integration between the drive 100 and the winch 301 is particularly pronounced because the drive 100 surrounds the winch 301 in a sandwich-like manner.

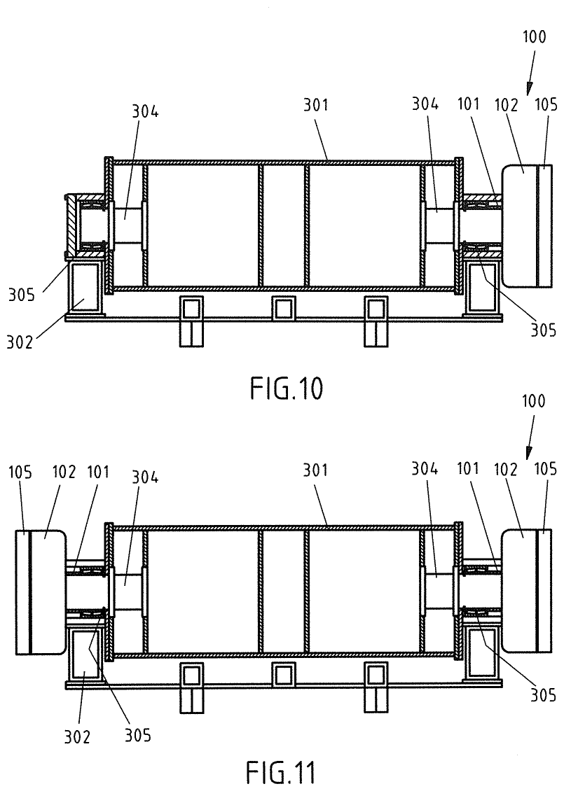

An additional exemplary embodiment of a cable winch 301 with a direct drive 100 for a vertical or horizontal accumulator is shown in FIG. 10. A variant in which the direct drive 100 is designed as an inrunner is shown. The direct drive 100 is similar to the one in FIG. 8, wherein a cooling module is omitted. The rotor 101 of the direct drive 100 and the shaft 304 of the winch 301 are formed to be integral, preferably in one piece. This makes it possible that the two winch-side bearings 305 are also used by the rotor 101 of the direct drive 100. An additional bearing inside the direct drive can therefore be omitted, if necessary.

In the exemplary embodiments shown, a direct drive was always provided for a roller/roll or winch to be driven. However, several direct drives can also be arranged on one or both sides of the roller/roll or winch. Similarly, one direct drive can drive several rollers/rolls or winches.

FIG. 11 shows an exemplary embodiment of a cable winch 301 for a vertical or horizontal accumulator with a direct drive 100 on both sides. In all other respects, the structure is similar to that of FIG. 10. Such a double-sided drive is possible in a similar manner for the rollers/rolls 200 shown in FIGS. 2a to 7.

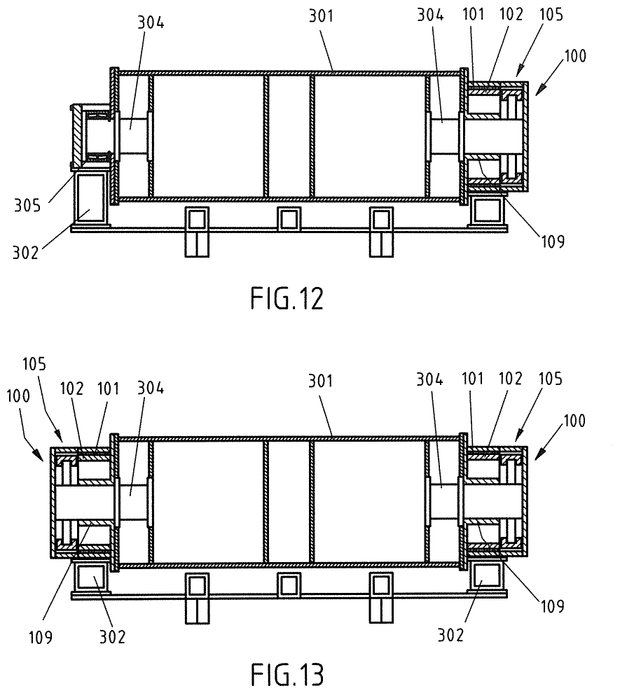

FIG. 12 shows an additional exemplary embodiment of a cable winch 301 with a direct drive 100 for a vertical or horizontal accumulator. A variant in which the direct drive 100 is designed as an outrunner and is thus integrated in the winch 301, similar to the exemplary embodiments described for rollers/rolls with reference to FIGS. 3 and 7, is shown. The direct drive 100 has an outer rotor 101 with magnets, which can be provided integrally or in one piece with the winch 301. The inner stator 102 is firmly connected to the winch frame 302. The shaft 304 of the winch 301 is rotatably mounted on the stator 102 via a bearing 109, which allows a particularly close integration between the direct drive 100 and the winch 301. The bearing 109 is located in a bearing housing shown in FIG. 12, but without reference signs. FIG. 12 shows a similar exemplary embodiment, but as in FIG. 11 with direct drive on both sides for increasing the torque and/or more even distribution of force and weight.

The following applies to all embodiments shown: A feed-through for media, such as hydraulic oil and/or cooling water, is possible from the drive side, for example by passing corresponding lines through the inner rotor or stator. The close, integral connection between the drive and the work machine allows for a system construction that saves installation space. This is accompanied by simplifications in system construction, for example by saving on foundations, better accessibility to the system, a reduction in spare parts, a reduction in maintenance work, a downsizing of the hall. The motors are not endangered, or are less endangered, by bundles or other falling parts. A major advantage of the concept presented here becomes apparent in the thermal design of the motors. Due to the intimate connection of the drive to the work machine, the mass and surface of the mechanical device can be used for heat dissipation. Thus, the power of the electric motors can be increased without any structural measures. The power loss of the drive train is considerably reduced. In many cases, forced ventilation or water cooling can be omitted. The motors can be designed as inrunners or outrunners. The integral concept described also offers improvements in terms of safety, since rotating external drive components such as cardan shafts, couplings, brake disks, etc. can be omitted. Components such as bearings, shafts, clutches, motor stands, gear stands, etc. are no longer required. A reduction in the number of moving parts also results in higher control accuracy, which in turn has a positive effect on the quality of the products to be manufactured.

The reduction in the number of components compared with a conventional drive train is expressed by the fact that certain types of gears, couplings and rolling bearings can be omitted completely or at least partially. Moving and stationary components are significantly reduced, resulting in higher torsional stiffness, improved control quality and higher efficiency of the drive system. The need for oil lubrication can be partially eliminated, further reducing the power loss of the drive. Motor fans or water coolers can be omitted or can be smaller, since the frame of the work machine and the stator of the drive are closely integrated, by which power loss is further reduced. A significant reduction in wear parts, such as gears and their bearings, improves the ability to maintain and the reliability of the machine. In addition, the drive train as a whole is extremely resilient, in particular with regard to possible shock loads. Furthermore, a reduction in operating noise and safety engineering expense is achieved, for example by eliminating covers for moving parts. System planning is simplified, since, in general, the drive trains have to be individually planned on a foundation with great expense. If the drive is integrated or “interlocked” with the roller element, such as the roller/roll or winch, as described in detail above, the effort involved in system planning is reduced. If necessary, the drive can also be interlocked with the frame of the work machine ex works. This means that the device can be tested in the production plant and arrives at the construction site tested, by which final assembly is simplified and the machine can be put into operation quickly.

To the extent applicable, all individual features shown in the exemplary embodiments can be combined and/or replaced without leaving the field of the invention.

### LIST OF REFERENCE SIGNS

| | |
|---|---|
| 10 | Drive/direct drive |
| 11 | Rotor |
| 12 | Stator |
| 13 | Supplying converter |
| 20 | Work machine |
| 30 | Holding device |
| 31 | Control device |
| 40 | Electric braking device |
| 50 | Mechanical holding device |
| 100 | Drive/direct drive |
| 101, 101′ | Rotor |
| 102, 102′ | Housing/stator |
| 103 | Bearing |
| 105 | Brake/brake module |
| 106 | Bolting |
| 107 | Pneumatic connection |
| 108 | Flexible coupling |
| 109 | Bearing |
| 110 | Catching magnet |
| 111 | Encoder system |
| 112 | Cooling shell |
| 113 | Cooling module/fan module |
| 114 | Axial cooling device |
| 200 | Roller/roll |
| 201 | Shaft |
| 202 | Frame/stand |
| 203 | Bearing |
| 204 | Suspension |
| 205 | Screw flange |
| 206 | Replaceable roller body |
| 207 | Roller base frame |
| 300 | Winch assembly |
| 301 | Winch |
| 302 | Winch frame |
| 303 | Cable |
| 304 | Shaft |
| 305 | Bearing |

1.-14. (canceled)

15. A device for handling a strip-shaped metal material in metal working, comprising:
at least one roller element which is provided for one or more of changing a cross-section of the strip-shaped metal material, transporting the strip-shaped metal material, storing the strip-shaped metal material, building up tension in the strip-shaped metal material and releasing tension in the strip-shaped metal material;
a drive, the drive having an electric motor with a stator and a rotor; and
a frame,
wherein the rotor is connected to the roller element such that a rotation of the rotor is transmitted to the roller element,
wherein the stator is mounted directly on the frame and/or the rotor is connected directly to the roller element or to a shaft of the roller element, and
wherein the drive has a modular structure and can be combined with additional modules, including at least one module selected from the group consisting of a brake module, a holding module, a gear module, a power increase module, and a cooling module.

16. The device according to claim 15, wherein the roller element is a roller, a roll or a winch.

17. The device according to claim 15, wherein the electric motor is a torque motor or a synchronous motor.

18. The device according to claim 15,
wherein the electric motor is an inrunner, and
wherein the rotor and the roller element or the rotor and a shaft of the roller element are formed in one piece.

19. The device according to claim 15,
wherein the electric motor is an outrunner, and
wherein a shell section of the roller element is connected to the rotor.

20. The device according to claim 19,
wherein the shell section of the roller element and the rotor are connected directly to each other or are formed in one piece.

21. The device according to claim 15, wherein
the frame supports the roller element on one side, while the frame has no second bearing for the roller element, but the roller element is supported on an opposite side via a rotor bearing of the drive, or
the frame supports the roller element on two sides and a separate support of the rotor in the drive is omitted.

22. The device according to claim 15, wherein two drives are connected to the roller element on opposite sides of the frame, the two drives comprising the drive and a further drive.

23. The device according to claim 15, wherein the rotor of the drive is connected to the roller element without interposition of a torque gear.

24. The device according to claim 15, wherein the drive has at least one catching magnet, which is configured to capture magnetic particles and keep them away from the electric motor.

25. The device according to claim 15, wherein the drive has a coupling for the rotor.

26. The device according to claim 25, wherein the coupling is a curved-tooth coupling.

27. The device according to claim 15,
wherein the device is part of a rolling mill and the roller element is a support roll or a work roll, or
wherein the device is part of a metal strip processing line and the roller element is a transport roller, a tension roller, an acceleration roller or a roller for tension build-up or tension release of the metal material, or
wherein the device is part of a strip accumulator with a winch assembly and the roller element is a cable winch.

28. The device according to claim 15, further comprising:
an electric braking device, which is configured to brake the device from an operating state without friction into a holding state, in which the rotor is essentially stationary;
a mechanical holding device, which is configured to mechanically lock the device in the holding state upon actuation of the mechanical holding device; and
a control device, which is configured to control the electrical braking device and the mechanical holding device in such a manner that essentially all of the kinetic energy from the operating state is converted by the electrical braking device, while the mechanical holding device is operated only in the holding state of the device.

29. The device according to claim 28,
wherein the drive has a supplying converter, which is configured to supply the electric motor of the drive with power in the operating state, and has a function for braking the device in a normal operating state, and
wherein the electric braking device and/or the control device is configured to galvanically isolate the supplying converter from the electric motor in an extraordinary operating state comprising a disturbance of the supplying converter, and to brake the device into the holding state by short-circuiting windings of the electric motor either directly or via a braking resistor or a resistor/capacitor circuit, and/or by connecting an external DC voltage source.

30. The device according to claim 28, wherein the drive has a housing in which the mechanical holding device is integrated or to which the mechanical holding device is flanged.

31. The device according to claim 28, wherein the mechanical holding device is configured in such a manner that the locking in the holding state takes place in a positive-locking and/or force-fitting manner.

32. The device according to claim 31, wherein the actuation of the mechanical holding device takes place electrically, mechanically, hydraulically or pneumatically.
